(19) United States
(12) Patent Application Publication
(10) Pub. No.: US 2007/0089412 A1
(43) Pub. Date: Apr. 26, 2007

(54) METHOD FOR CONTROLLING AN EXHAUST GAS RECIRCULATION SYSTEM

(76) Inventor: Arnd Sommerhoff, Aachen (DE)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/539,311

(22) Filed: Oct. 6, 2006

(30) Foreign Application Priority Data
Oct. 22, 2005 (DE) 102005050690.9

(51) Int. Cl. F02B 29/04; F02B 33/44

(52) U.S. Cl. 60/599; 60/605.2

(57) ABSTRACT

The invention relates to an arrangement for controlling an exhaust gas flow through an exhaust gas recirculation system for an internal combustion engine having a turbocharger. The exhaust gas recirculation system has an exhaust gas cooler and a bypass which is capable of diverting at least a portion of exhaust gas flow from the cooler, the exhaust gas cooler and the bypass each being assigned a separate valve for enabling and disabling the flow of the exhaust gas. At full load of the internal combustion engine, the valves are closed together and/or at the same time. The valves are arranged at the upstream side of the exhaust gas recirculation system. When the two valves are closed, the exhaust gas recirculation system is decoupled from.

### FIELD OF INVENTION

The invention relates to a method and a system for controlling an exhaust gas flow of an internal combustion engine, and more particularly to an exhaust gas recirculation system from an exhaust system of an internal combustion engine having a turbocharger.

### BACKGROUND AND SUMMARY OF THE INVENTION

DE 100 25 877 C2 relates to an exhaust gas recirculation system having a cooler, a bypass, a cooler valve for opening and closing the cooler supply and a bypass valve for opening and closing the bypass. The cooler valve and the bypass valve have a common drive in the form of a rotary drive which can rotate in two directions, or a vacuum source. It is intended in this way to produce an exhaust gas recirculation system in which it is possible, in an effective way and with a simple construction of the entire valve arrangement, to control the exhaust gas temperature by selectively passing flow through the cooler or the bypass. DE 100 25 877 C2 discloses, in one embodiment of the exhaust gas recirculation system, the provision of a common valve element for the cooler valve and the bypass valve, said common valve selectively opening the cooler supply or the bypass and closing the respective other inlet, or else closing both lines.

Known exhaust gas recirculation systems serve to recirculate the exhaust gas which is discharged from the internal combustion engine into the air supply system of the internal combustion engine. The temperature of the exhaust gas conventionally changes as a function of the operating state of the engine or internal combustion engine. For example, when the internal combustion engine is cold, the bypass is opened and the exhaust gas cooler is closed, so that the exhaust gas is guided not through the exhaust gas cooler but rather through the bypass, with a higher temperature of the combustion gas supplied to the internal combustion engine improving and/or stabilizing the ignition conditions and the combustion of the internal combustion engine. A coolant of the internal combustion engine flows through the exhaust gas cooler. During the warm-up phase of the internal combustion engine, the bypass is closed and the exhaust gas cooler is opened, so that heat recirculation from the hot exhaust gas to the coolant of the internal combustion engine takes place in the exhaust gas cooler, with the exhaust gases heating up the coolant, resulting in the warm-up phase of the internal combustion engine being reduced. When the internal combustion engine is hot or has been in its operating phase for a relatively long period of time, the cooler bypass is closed and the exhaust gas cooler is opened, resulting in the exhaust gas temperature and simultaneously NOx emissions being reduced.

The exhaust gas recirculation system with its exhaust gas cooler and its bypass can, however, act in the manner of a Helmholtz resonator which significantly influences the gas dynamics in the exhaust gas system. The exhaust gas recirculation system can, for example, exert a damping effect on the gas dynamics (vibration), so that the exhaust gas recirculation system uses up exhaust gas energy which, in internal combustion engines having turbochargers, is then not available for driving the exhaust gas turbine or the turbocharger and therefore for compressing the air. This results in a loss in the power capacity of the turbocharger used in each case and therefore ultimately in a reduction in the performance increase of the internal combustion engine which can be obtained by means of the turbocharger. However, the gas dynamics in the exhaust gas system has a positive influence on the turbocharger power, in particular in the mid-speed range of the internal combustion engine.

The present invention is therefore directed to an improved method and system for controlling an exhaust gas flow through an exhaust gas recirculation system such that the gas dynamics in the exhaust system are maintained, so that the turbocharger power is increased.

Accordingly, an exhaust gas recirculation system for an exhaust system for an internal combustion engine having a turbocharger, includes: an exhaust gas cooler having a first valve for selectively enabling and disabling exhaust gas flow through said cooler; a bypass for diverting at least a portion of exhaust gas flow from said exhaust gas cooler, said bypass having a second valve for selectively disabling exhaust gas flow through said bypass; and a controller providing an indication of an engine operating condition, and in response to said indication controlling said first and said second valves to substantially disable exhaust gas flow through said cooler and said bypass thereby substantially decoupling the exhaust gas recirculation system from the exhaust system of the internal combustion engine.

Within the context of the invention, the upstream side of the exhaust gas recirculation system is the side at which the exhaust gas traveling from the internal combustion engine enters or flows into the exhaust gas recirculation system. By decoupling the exhaust gas recirculation system from the exhaust system at full load of the internal combustion engine according to the invention, it is advantageously achieved that the gas dynamics are maintained, so that the turbocharger can provide its full power, in particular at full load, preferably in a mid-speed range of the internal combustion engine. A dead volume of the exhaust gas recirculation system which is connected to the exhaust system is therefore minimized.

Within the context of the invention, it is favorable if the exhaust gas recirculation system is assigned an exhaust gas recirculation valve at downstream side, said exhaust gas recirculation valve regulating the exhaust gas recirculation flow.

Arranging the exhaust gas recirculation valve on the upstream side would disadvantageously result, for example, in increased expenditure for cooling the exhaust gas recirculation valve. For this reason, the exhaust gas recirculation valve is advantageously arranged on the downstream side, so that, for example, its cooling problems are solved, though the valves of the exhaust gas cooler and of the bypass must simultaneously be arranged on the upstream side of the exhaust gas recirculation system and be simultaneously closed at full load, so that the exhaust gas recirculation system is decoupled from the exhaust system.

In order to provide that the two valves close both the exhaust gas cooler and the bypass together and/or at the same time, it is expedient within the context of the invention for it to be possible for the two valves to be actuated separately. It is of course also possible in a further embodiment for the two valves to be actuated together.

It will be appreciated that features of the invention are susceptible to being combined in any combination without departing from the scope of the invention as defined by the accompany claims.

### BRIEF DESCRIPTION OF THE DRAWINGS

By way of example only, embodiments of the present invention will now be described with reference to the accompanying drawings wherein:

FIG. 1 is a principle illustration of a system for controlling an exhaust gas flow through an exhaust gas recirculation system;

FIG. 2 is a diagram for illustrating a dynamic pressure profile upstream of the turbocharger; and

FIG. 3 is a diagram for illustrating the mean effective cylinder pressure versus the engine speed.

### DESCRIPTION OF PREFERRED EMBODIMENT(S)

In the different figures, identical parts are always provided with the same reference symbols, so that said parts are generally also described only once.

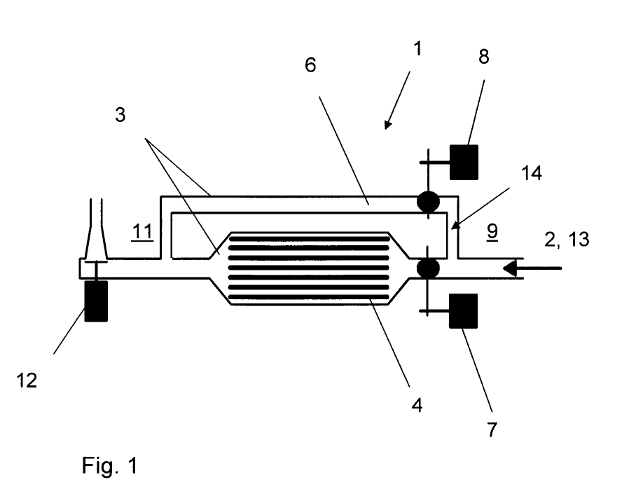

FIG. 1 shows an arrangement 1 for controlling an exhaust gas flow 2 through an exhaust gas recirculation system 3 internal combustion engine (not illustrated) having a turbocharger (not illustrated). The exhaust gas recirculation system 3 has an exhaust gas cooler 4 and a bypass 6 which bypasses said exhaust gas cooler 4. The exhaust gas cooler 4 and the bypass 6 are each assigned a respective separate valve 7 and 8 for opening and closing either the bypass 6 or the exhaust gas cooler 4. The valve 7 is assigned to the exhaust gas cooler 4, and the valve 8 is assigned to the bypass 6. At full load of the internal combustion engine, the valves 7 and 8 of the exhaust gas cooler 4 and of the bypass 6 are closed together, the valve elements 7 and 8 being arranged at the upstream side 9 of the exhaust gas recirculation system 3, so that the exhaust gas recirculation system 3 is decoupled from the exhaust system at full load of the internal combustion engine.

In the illustrated exemplary embodiment, the valves 7 and 8 can be actuated separately.

The exhaust gas recirculation system 3 is assigned an exhaust gas recirculation valve 12 at its downstream side 11 situated opposite the upstream side 9, said exhaust gas recirculation valve 12 regulating the quantity of the exhaust gas recirculation flow.

When the two valves 7 and 8 are moved into the closed position illustrated in FIG. 1, the exhaust gas recirculation system 3 is decoupled from the exhaust system, so that a dead volume 14 of the exhaust gas recirculation system which is connected to the exhaust system is minimized. The dead volume 14 is arranged, as viewed in the flow direction (arrow 13), to the right-hand side of the closed valves 7 and 8 in the plane of the drawing.

In this way, it is advantageously achieved that the gas dynamics in the exhaust system are conserved and are not adversely affected, so that as far as possible the entire exhaust gas energy is available to the turbocharger in particular in the mid-speed range of the internal combustion engine.

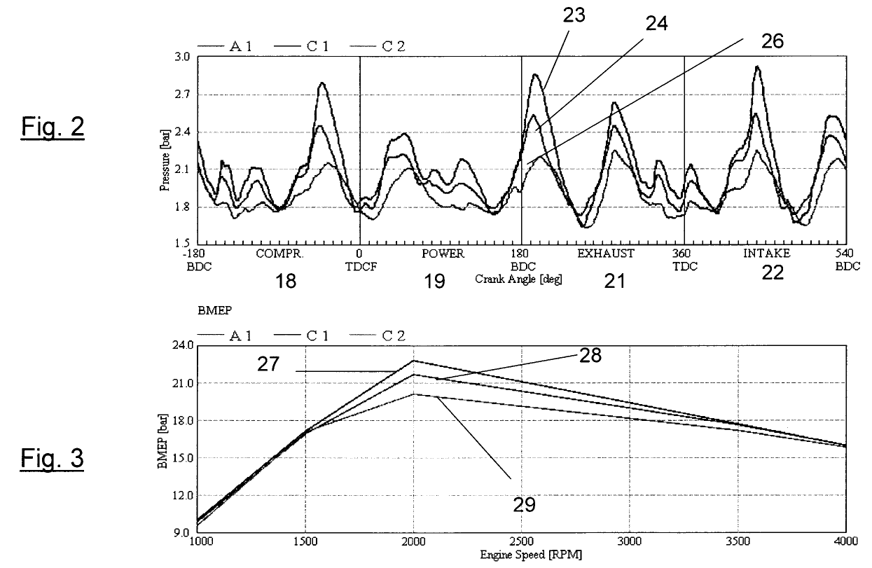

The advantageous effect of the control arrangement according to the invention is illustrated in FIGS. 2 and 3. In the diagram, FIG. 2 shows the dynamic pressure profile upstream of the turbine or upstream of the turbocharger versus the engine speed (in crankshaft angle degrees). FIG. 2 also illustrates working strokes 18, 19, 21, 22 (compression 18, working 19, exhaust 21, intake 22) on the crankshaft angle axis.

FIG. 2 illustrates three dynamic pressure profiles 23, 24, 26, the dynamic pressure profile 23 corresponding to the pressure profile using the control arrangement 1 according to the invention. The pressure profile 24 corresponds to an arrangement for controlling the exhaust gas flow 2 through the exhaust gas recirculation system 3 with the valve 7 of the exhaust gas cooler 4 closed and the valve 8 of the bypass open. The pressure profile 26 corresponds to a control arrangement in which the two valves 7 and 8 are arranged on the downstream side 11 of the exhaust gas recirculation system 3 and are closed at the same time and/or together.

It can be gathered from FIG. 2 that the control arrangement according to the invention generates higher pressure peaks in the dynamic pressure upstream of the turbocharger. The amplitudes of the dynamic pressure profiles 24 and 26 are considerably reduced as a result of the adversely affected gas dynamics.

As can be gathered from FIG. 3, this results in a corresponding profile of the mean effective cylinder pressure (Brake Mean Effective Pressure=BMEP, equivalent to the torque profile) 27, 28 and 29, the BMEP profile 27 being generated by means of the control arrangement 1 according to the invention, and the profile 28 being generated by a circuit corresponding to that of the pressure profile 24, and the profile 29 being generated by a control arrangement corresponding to that of the pressure profile 26. It can be clearly seen in FIG. 3 that the profile 27 of the mean effective cylinder pressure resulting from the control arrangement according to the invention is significantly more favorable than the other two profiles 28, 29.

The control arrangement according to the invention therefore advantageously provides that a significantly greater amount of energy is available to the turbocharger, and the internal combustion engine accordingly generates more power, at full load of the internal combustion engine, in particular in the mid-speed range.

1. An exhaust gas recirculation system for an exhaust system for an internal combustion engine having a turbocharger, comprising:
an exhaust gas cooler having a first valve for selectively enabling and disabling exhaust gas flow through said cooler;
a bypass having a second valve for selectively disabling exhaust gas flow through said bypass; and
a controller providing an indication of an engine operating condition, and in response to said indication controlling said first and said second valves to substantially disable exhaust gas flow through said cooler and said bypass thereby substantially decoupling the exhaust gas recirculation system from the exhaust system of the internal combustion engine.

2. The exhaust gas recirculation system as claimed in claim 1, wherein the exhaust gas recirculation system further comprises an exhaust gas recirculation valve coupled downstream of said cooler.

3. The exhaust gas recirculation system as claimed in claim 2, wherein said first and said second valves can be actuated separately.

4. The exhaust gas recirculation system as claimed in claim 3, wherein said first and said second valves can be actuated together.

5. The exhaust gas recirculation system as claimed in claim 4, wherein said engine operating condition is full load.

6. The exhaust gas recirculation system as claimed in claim 4, further comprising an exhaust gas recirculation valve coupled downstream of the exhaust gas recirculation system.
